(19) United States
(12) Patent Application Publication
(10) Pub. No.: US 2009/0271260 A1
(43) Pub. Date: Oct. 29, 2009

(54) Systems, Methods and Computer Program Products for Researching, Planning, Building, Purchasing and Tracking Digital Online Media Advertising

(75) Inventors: Vishal Sharma, Pune (IN); Devaraj Southworth, New York, NY (US)

Correspondence Address: KALOW & SPRINGUT LLP, 488 MADISON AVENUE, 19TH FLOOR, NEW YORK, NY, 10022, US

(73) Assignee: (!)YUREEKAH, LLC, New York, NY (US)

(21) Appl. No.: 12/110,814

(22) Filed: Apr. 28, 2008

(51) Int. Cl. G06Q 30/00

(52) U.S. Cl. 705/14

(57) ABSTRACT

Improved systems, methods and computer program products are provided for improving the efficiency and quality of the process of purchasing digital and online advertising. Through the use of the invention, one may more effectively use competitive research, build a media plan, generate a creative piece from scratch for an advertising campaign, purchase media across multiple publishers and track the campaign through a single web based platform.

### FIELD OF THE INVENTION

The present invention is directed to the field of online media advertising.

### BACKGROUND

The digital and online media industry is growing at a rate of between 60% and 70% year over year. With this growth has come a significant challenge in how to manage and to use this media. The challenge is particularly onerous for persons who seek to use the world-wide-web as a forum for advertising.

The basic process for launching an advertising campaign, regardless of the type of media in which it is launched implicates five basic steps: (1) competitive research; (2) media planning; (3) building of creative pieces for a campaign; (4) publishing a campaign across one or more various publishers; and (5) tracking whether the media is seen through a particular publisher and/or whether the media leads to increased business.

However, when an advertising campaign is launched within online media, the process becomes more complicated because online media campaigns are typically evaluated in real time. Moreover, the campaigns may be as short as one day, or as long as three months. Still further, they may span across various continents and be launched in various time zones and languages.

Furthermore and as persons of ordinary skill are aware, online media may be launched through any one or more of the thousands of publishers world wide. Each of these publishers represents a possible platform for an ad network, an adserver and a gateway to search for marketing opportunities (also known as a search marketing gateway). Adding still another wrinkle, there is no standardization of formats to be used by these various publishers.

Advertisers are aware of many of the aforementioned issues. However, there is no system that adequately addresses these issues and enables an advertiser to select among the numerous publishing opportunities and to market on the web efficiently. The present invention is directed to improving the use of online media advertising and addressing these inefficiencies, as well as in some embodiments be an end-to-end solution for the lifecycle of an online media campaign.

### SUMMARY OF INVENTION

The present invention provides methods, systems and computer program products for improving and rendering more efficient the selection and placement of online media campaigns.

According to one embodiment, the present invention provides a method for providing competitive analysis of online advertising to a user, said method comprising: (i) populating a search database with online media content files, wherein said populating comprises scraping a plurality of URLs; (ii) indexing said search database to provide a set of key words for each online media content file, wherein each set of key words is associated with each online media content file; (iii) searching within said key words for results, wherein said results comprise or describe a set of online media content files that match a user defined query; and (iv) displaying said results to said user.

According to another embodiment, the present invention provides a method for selecting and purchasing online media content, said method comprising the method of the previous embodiment and further comprising: (i) reviewing said results; (ii) applying a user defined criteria with respect to at least one of the following pieces of information with respect to at least one publisher, budget, duration of advertisement placement, location, target audience and key words; (iii) selecting a publisher for launching an online advertisement, wherein said publisher satisfies one or more of said user defined criteria; and (iv) placing an order for placement of an advertisement through said publisher for launching.

According to a third embodiment, (which may for example be used alone or in conjunction with the first embodiment described above) the present invention provides a computer-based system for determining placement of online advertising, wherein said computer-based system comprises: (i) a scraper module, wherein said scraper module is capable of scraping a frame of an online content page in which an advertisement appears, thereby yielding a scraped frame; (ii) an index module, wherein said index module is configured to extract key words from said scraped frame, and said index module is configured to be able to extract said key words from a plurality of file formats and to generate an index of key terms; (iii) an input module, wherein said input module is capable of receiving a query for searching said index; and (iv) an output module wherein said output module is capable of displaying results of said query to a user, wherein said index module is operably coupled to said scraper module, said input module and said output module.

According to a fourth embodiment, (which also may for example be used alone or in combination with the first embodiment described above) the present invention provides a computer readable storage medium for storing instructions that when executed by a computer cause the computer to execute a method for facilitating reviewing online media advertising, wherein said method comprises: (i) scraping online media, wherein said scraping comprises (a) reading a list of URLs from within a URL database, (b) allocating a thread for fetching to each URL, (c) retrieving web page content for each URL, (d) analyzing said web page content to determine whether advertisements appear on said web page, (e) downloading advertisements from said web page content into an advertisement database; (ii) indexing said advertisement database; (iii) searching said advertisement database based on a set of criteria to generate results that satisfy said set of criteria; and (iv) displaying said results to a user. By way of example, the URL database may comprise a list of URLs that are known to be sites on which online media content is published.

According to a fifth embodiment, the present invention provides a computer readable storage medium for storing instructions that when executed by a computer cause the computer to execute a method for purchasing online media advertising comprising the method of the previous embodiment and further comprising instructions that when executed cause the computer to purchase online media from a publisher. In some embodiments, the publisher previously published an advertisement that appeared in said results.

According to a sixth embodiment, the present invention comprises a computer program product that comprises six modules: (i) a search module; (ii) a plan module; (iii) a create module; (iv) an optimization module; (v) a purchase and launch module; and (vi) a tracking module. Although the modules may be used independently, in one exemplary system, a user first activates a search module in order to review the results of scraping and indexing of existing advertisements on the Internet. The user may then input one or more variables into a plan module that allows the user to feed information about variables that are important to it, e.g., budget, duration of advertisement placement, location, target audience, key words, etc. Through a computer program, these variables are measured against a set of parameters that describe opportunities for marketing that are available from publishers and a marketing plan is generated. The user may then optionally use a create module, which allows him to follow a step-by-step process for creating an advertisement. Next, he may use an optimization module that optimizes the creative pieces' sizes for prospective portals (e.g., publishers who were identified in the previous steps). After potential publishers are identified, a user may purchase advertising opportunities and cause the launch to be initiated. The launched advertising campaign may then be tracked through a tracking module. Each of these modules may be operably coupled to one or more of the other modules.

According to a seventh embodiment, the present invention provides a method that is directed to creation of an online media campaign that may be used alone or in combination with other embodiments provided herein. The method comprises one or more, if not all of the following steps: (1) defining a canvas or banner size and weight; (2) defining the number of slides/frames for the banner; (3) filling background images or color for the frames; (4) inserting images for the library at preset space allocations; (5) inserting text after selecting the font from the library; (6) inserting company logo from a desired file source at preset locations; and (7) downloading or saving the file for future use after making a payment for the same through e.g., an online payment gateway.

According to an eighth embodiment, the present invention provides a method for optimizing the configuration of an online media campaign that may be used alone or in combination with other embodiments provided herein. The method comprises optimizing the size of an online media advertisement based on portal centric parameters.

According to a ninth embodiment, the present invention provides a method for tracking an online media campaign that may be used alone or in combination with other embodiments provided herein. The method comprises monitoring click throughs and/or impressions of an advertisement that has been placed with a publisher.

Through the various embodiments of the present invention, one may accomplish one or more of the following benefits: (i) vertical integration of a plurality of aspects pertaining to online media; (ii) automation of researching, planning, creating, launching and/or tracking online media campaigns, thereby increasing efficiency; and (iii) introducing effective data mining capabilities as a tool for market research to enable the mapping of user trends.

### BRIEF DESCRIPTION OF THE INVENTION

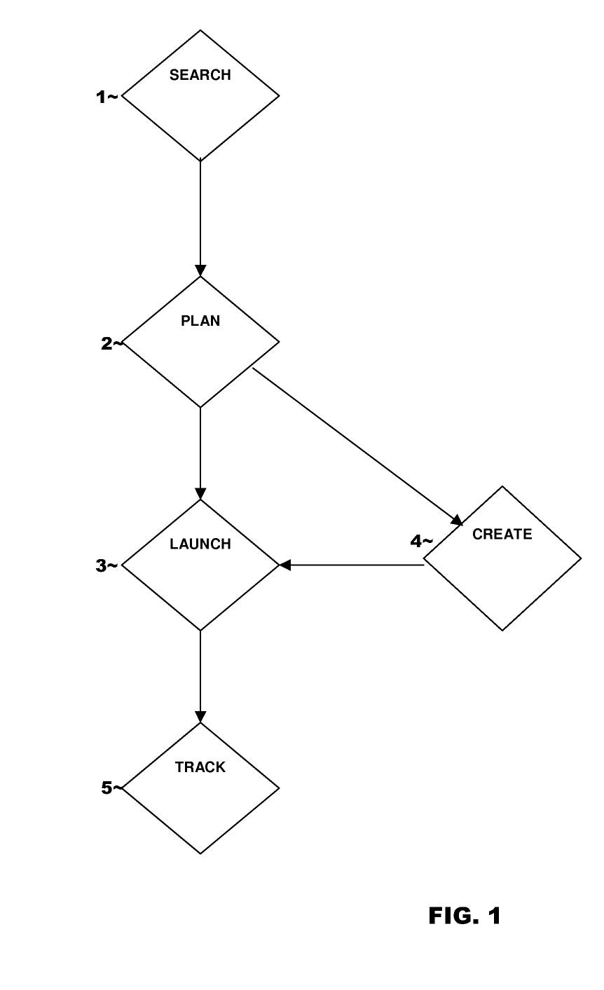

FIG. 1 is a representation of five modules of an embodiment of the present invention.

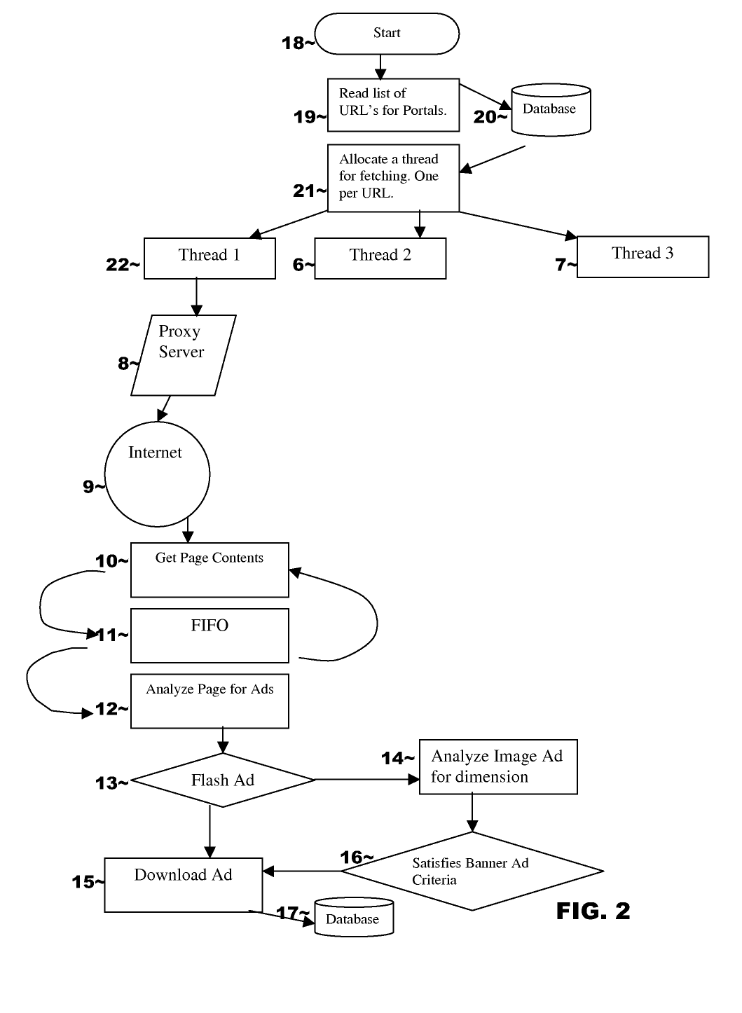

FIG. 2 is a representation of a method of scraping according to the present invention.

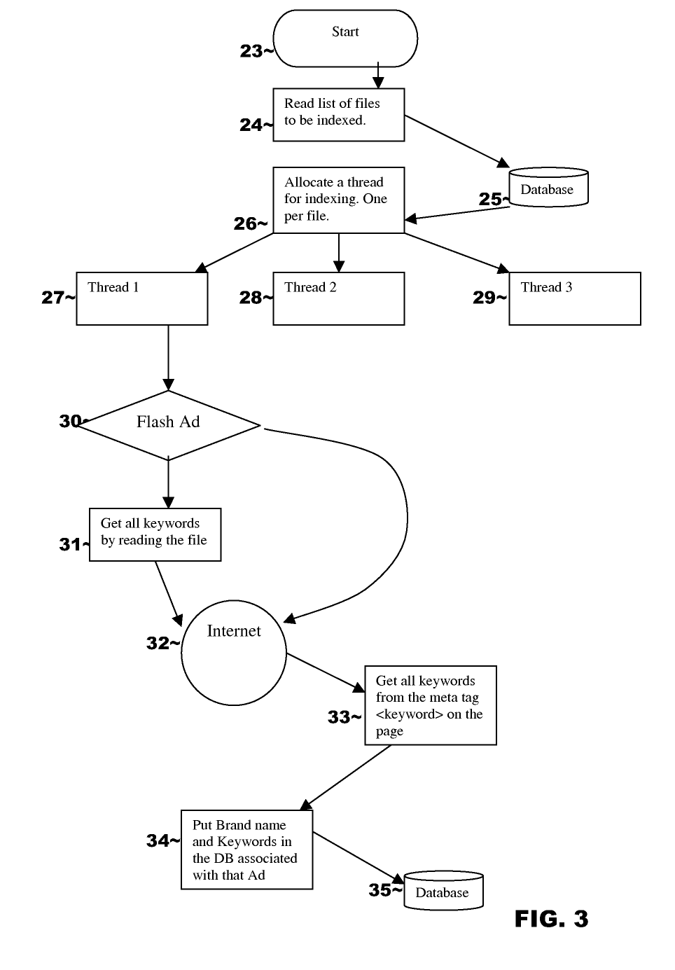

FIG. 3 is a representation of a method of indexing according to the present invention.

### DETAILED DESCRIPTION

### Definitions

Unless otherwise specified or apparent from context, the following terms and phrases have the meanings provided below:

The phrase “ad content” refers to the elements of an advertisement, including but not limited to the advertisement's text, description, images, artwork and logos.

The phrases “ad network” and “advertising network” refer to a company that connects web sites that host advertisements with advertisers that are designed to run advertisements.

The terms “adserver” refers to a web server that hosts advertisements that are used in online marketing. The content of the web server is constantly updated so that the website or webpage on which the ads are displayed contains new advertisements—e.g., banners (static images/animations) or text—when the site or page is visited or refreshed by a user. An adserver may also perform various other tasks including but not limited to counting the number of impressions/clicks for an ad campaign and report generation, which helps in determining the return on investment for an advertiser on a particular website.

The term “coupled” means that after accessing one module or system a second module or system may be accessed without opening or closing different programs. The modules and/or systems may comprise one or more hardware, software, or hybrid components residing in or distributed among one or more local or remote computers. The modules may be physically separated or together and may each be a logic routine or part of a logic routine that carries out the embodiments disclosed herein.

The term “crawling” refers to browsing the world-wide-web or other network through the use of a program or automated script in a methodical, automated manner.

The phrase “creative piece” refers to the concept, design and artwork in an advertisement.

The phrase “fetcher thread” refers to the instruction to look to a particular URL during a web crawl.

The term “Flash” refers to a set of multimedia technologies that is distributed by Adobe Systems. It is a well-known method for adding animation and interactivity to web pages. It is commonly used to create animation, advertisements and various webpage components for integration into web pages. When reference is made herein to Flash technology, it is understood to refer to systems that have the similar operating capabilities.

The phrase “headless browser” refers to a browser object that does not have an attached user interface component. Headless browsers make it possible to run web application tests in the background. When a test fails and requires debugging, one can switch to a version of the test with a graphic user interface browser for a better understanding of what is occurring.

The term “impression” refers to an instance in which an advertisement is viewed. This applies particularly to online advertising. A single user often gets several impressions as he browses through a website.

The term “indexing” refers to collecting parses and storing data in order to facilitate fast and accurate information retrieval. Index design incorporates interdisciplinary concepts from linguistics, cognitive psychology, mathematics, informatics, physics and computer science.

The phrase “internal database feed” refers to a set of database lists generated by a set of people/users that is fed into the systems of the present invention. It may provide the list of URLs to be scraped.

The phrase “IP mapping” refers to the Internet Protocol, which is a means of finding out where a user is based and based on the location of the user, providing demographic specific content.

The phrase “key word” refers to a word that may be present in an online media files, e.g., in a meta-tag and/or text file and/or flash file. A key word listing may include all words that appear as meta-tags or text or components of a flash file in on-line media files that have been reviewed or a subset of terms that appear in meta-tags.

The phrases “landing page” and “lead capture page” are used interchangeably and refer to the web page that appears when a potential customer clicks on an advertisement or a search-engine result link. The page will usually display content that is a logical extension of the advertisement or link, and that is optimized to feature specific key words or phrases for indexing by search engines.

The phrase “module” refers to a computer program product that may be stored on hardware and/or software that may be activated by a user to carry out a defined set of steps and/or to prompt a user to provide information through for example a graphic user interface and/or input/output device. Each module may be used on a separate platform or a plurality of modules may be run off of the same platform.

The term “multimedia” refers to information that can sustain text, images, audio, video and/or any other type of information, e.g., an online format.

The phrase “online advertising” refers to a form of advertising that uses the Internet and the world wide web in order to deliver marketing messages and to attract customers.

The phrase “online media” refers to Internet sites or servers in which content is available for browsers. Internet sites may for example be written in various formats, including but not limited to html, and they are viewable through an Internet browser.

The phrase “operably coupled” refers to any connection that allows interoperability, including for example, being communicably coupled.

The term “Plesk” refers to a web hosting automation solution. It allows a server administrator to set up new websites, email accounts, and DNS entries through a web-based interface. The administrator can create client and site templates, which predetermine resource allocation parameters for the domains and/or clients. The use of the term Plesk herein is not intended to limit the applications to any one product or service and is meant to include all similar products and services that serve the same function.

The phrase “representational state transfer” and the acronym “REST” are used interchangeably and refer to a stateless client-server architecture in which web services are viewed as resources and can be identified by their URLs. Web service clients who want to use these resources may access a particular representation by transferring application content using a small globally defined set of remote methods that describe the action to be performed on the resource. REST is an analytical description of the existing web architecture and thus the interplay between the style and the underlying http protocol appears seamless.

The phrase “rich media” refers to a web page advertisement that uses technology such as streaming video, downloaded applets (programs) that interact instantly with the user, and advertisements that change when the user's mouse passes over it.

The term “scraping” refers to a technique in which a computer program extracts data from the display output by another program.

The abbreviation “URL” refers to a uniform resources locator.

### PREFERRED EMBODIMENTS

The present invention is directed to improvements in reviewing, selecting and purchasing online media. Through the use of the methods, systems and computer program products described herein, a user can have an improved online media review and procurement experience.

Sectional headers provided in this description are provided for the purpose of assisting the reader in understanding where a description of a particular aspect of the invention is located. It is understood that aspects of the present invention may also be provided throughout the description, drawings and claims. Thus, the headers do not limit the invention in any way.

In various embodiments the present invention comprises one or more of the modules that are described below. Thus, each module may be used independently and/or in conjunction with any other additional module.

The Search Engine Module

The search engine module is directed to surveying the Internet for current online marketing campaigns and may comprise three components: (1) a scraper; (2) an indexer; and (3) a research search user interface. Each of the elements may be operably coupled to one another and may be a separate module in and of itself.

The scraper module enables one to search the media of a plurality of publishers to populate a database. The media may for example, be in the form of flash, gif, jpeg, mpeg and rich media formats, as well as combinations thereof. In order to carry out the scraping, a program may first look to a pre-determined or pre-fed list of uniform resource locators. The list may for example, come from feed designed to self generate content from external crawling and internal database feed. In some embodiments humans identify and input a list of URLs into a database. The content pages may as noted above be located by accessing the pre-determined URL sites, e.g., msn.com, yahoo.com aol.com, cnn.com, forbes.com, parenting.com, parenthood.com, latimes.com, nytimes.com and Travelocity.com.

In some embodiments, the scraper of the present invention is browser based. Thus, a user of the methods, systems and computer products of the present invention can access the scraper over a network such as the Internet through his browser. Additionally, in some embodiments, the scraper extracts content by scraping the frames of the content page in which an ad appears.

Identification of publishers and pre-fed lists of URLs may be obtained by for example, obtaining an index of well-known publishers of on-line media, reviewing those sites to determine whether they in fact display a threshold number and/or frequency of advertisements and manually typing the URLs of those publishers into a database of an index of publishers and URLs for scraping.

Alternatively or additionally, one could use a computer program product that is able to identify potential publishers through traditional search tools such as Google or Yahoo!, and that also contains a filter through which potential publishers are selected for inclusion in the index of publishers and URLs for scraping only if they meet certain criteria, e.g., meta-tag composition or impression frequency.

Traditionally scrapers focused on text files. However, the scraper of the present invention may scrape both text and visual media, including but not limited to flash files, jpeg, gifs and video (e.g., mpeg). Thus, in this process a web page may be scanned for file formats that contain one or more of swf, gif, jpeg and mpeg, and each of these may be put into the database. These files may be identified by their file extensions. The computer program product of the present invention may also be designed such that if during a process of scraping, a page is analyzed that includes a direction to other URLs, these other URLs may also be accessed and then used for scraping.

The program may assign a fetcher thread to each URL. The fetcher thread queries REST web services that in turn may use a headless browser to fetch the page and to return it back to the thread. The fetcher thread makes use of various proxy servers for IP mapping. This operation is repeated for each link within each URL address, thus there are multiple threads for the same and multiple publishers and each thread has the potential to link to other URL sites thereby initiating the scraping of more sites.

For example, if the URL of Yahoo is provided, a headless browser indexes all links of Yahoo and scrapes each link (which is in excess of 60,000 links). During the scraping each page of each link may be analyzed for the presence of media files, which are then examined for the presence of clickTags. If there is a clickTag, the clickTag will direct the system to a landing page. On that landing page meta-tags are analyzed for key words and for brands, which may be denoted as titles on that landing page. Ultimately, these key words and brands are what will be saved in the index.

It should be noted that if the multimedia file is in the form of a Flash file, the scraper may obtain key words for indexing from the meta-tags of the Flash file and/or by directly reading and ripping them from the Flash file. Thus, there are two ways to obtain key word information from a Flash file. By contrast, if the multimedia file is not a Flash file, then the scraper may go to the landing page that the multimedia file identifies and extract the key words.

As noted above, the scraper may identify files to be reviewed by the presence of a clickTag.

The scraping and subsequent indexing may be done in real time and cycled regularly or irregularly. For example, the scraping and indexing may be repeated daily, twice a day, hourly, twice an hour, every five minutes, every minute, every second or every millisecond.

In some embodiments, the scraping comprises analyzing a plurality of links of a URL for media files that have an extension of at least one of jpeg, swf, gif or mpeg, and reviewing a landing page to which said at least one of jpeg, swf, gif or mpeg points for meta-tags. If these meta-tags are present, the associated media content file may be saved, and the meta-tags may form part of the index described below.

The indexer analyzes the downloaded advertisement content and may categorize this content into various media types, including but not limited to (1) swf; (2) jpeg; (3) gif; and (4) other rich media formats, e.g., mpeg. Each advertisement may be analyzed using for example, a third party freeware library of java files that allows the indexer described above to analyze the key words and to index the key words in a database, as well as converting the content/message of the advertisement into key words that are stored in the database such that the advertisement is associated with respective key words. An exemplary program for indexing is available from J. Generator by Dimitri Scavish;

(flashgap.com)

As persons of ordinary skill are aware, a clickTag is the tracking code assigned by an ad serving network to an individual advertisement. The clickTag allows the network to register where the ad was displayed and when a user clicks on it. This click through data is then reported to the ad serving servers so that advertisers may determine the effectiveness of a campaign. This service is available through for example Macromedia. The index module may obtain this information (e.g., through the scraper module or other appropriate module) and index this information (click throughs and impressions) as well for later searching.

The results search user interface collates the information from the scraper and the indexer and acts as a gateway for users to search queries and to retrieve results. The search can be used for querying brands and/or key words. Based on the query of the user, the engine associates the database with the query and fetches the result based on the input of the brand/key word and the demography.

It is within the spirit and the scope of the search engine module of the present invention for a user to tap into an already indexed database or to initiate a new scraping process that will create a new database or add to an existing database. Further, this module may have a set list of URLs that are scraped, invite a user to create his own list from scratch, invite a user to supplement the URL list that exists in the module, invite a user to select a subset of URLs from a list within the module and/or invite a user to supplement a subset of the URLs within the search module.

The Planning Module

After or before searching, one may activate a planning module. The planning module comprises a web-based platform that includes a front end that assimilates data based on permutations and combinations of pre-fed real time data in the back-end. The back end comprises a database of a plurality of portals/Ad Networks that include inventory availability, creative size weights, prices, etc. Thus, the front end assimilates the data based on the parameters provided and the back end matches the parameters with potential publishing opportunities.

On the front end, a user inputs information such as that selected from the following list: budget, desired duration of time in which advertisement will run, location in which advertisement will run, key words, target audience and combinations thereof.

The variables are then scored against one or more variables selected from the following non-exhaustive list of publishers or publishing opportunities: (a) website for advertisement placement; (b) region of placement; (c) market; (d) vertical connections; (e) monthly impressions; (f) unique users; (g) country wide IP impressions; (h) availability of creative sizes; (i) permissible creative weights; (j) permissible innovations; (k) property placements; (l) pricing in multiple currencies; (m) minimum buy; (n) rates; (o) taxes; (p) discounts; and (q) contact information.

Through this matching and scoring, a user may be provided with a plan for marketing. Accordingly, after the computer receives this information it may display or output a plan or a number of plan options to a user. The plan may also be recorded on a computer hard drive or other electronic media.

The Create Module

The create module is an optional module that permits a creator to use a do it yourself web platform. The creator (user) may be guided through a clear path of building creative pieces without having to understand the technical nuances. Thus, one may use a library of backgrounds, illustrations, fonts and preset animations to create advertisements.

Exemplary steps through which a user may be guided include but are not limited to one or more of: (1) defining a canvas or banner size and weight; (2) defining the number of slides/frames for the banner; (3) filling background images or color for the frames; (4) inserting images for the library at preset space allocations; (5) inserting text after selecting the font from the library; (6) inserting company logo from a desired file source at preset locations; and (7) downloading or saving the file for future use after making a payment for the same through e.g., an online payment gateway. The order of these steps as described in this paragraph is an exemplary order in which a user may perform them.

By way of example, a user may login to a computer-based platform and select to create rich media advertisement or a graphical advertisement. From there, the user may be guided to specify dimensions according to IBB standards, create a background using the tools provided, specify effects and other parameters, and optimize the advertisement based on portal centric parameters. In a commercial embodiment, he may then be asked to pay for the transaction. The advertisement may be saved and uploaded to the user after the payment process is complete. Alternatively, there may be no payment process and/or the advertisement could be released or previewed prior to payment.

An advertisement may also be optimized with respect to sizing parameters. For example, after a user uploads a rich media advertisement or graphical advertisement, he may run an optimizer module that analyzes the advertisement using a swf library or graphics module and then optimize the advertisement based on portal centric parameters.

The Purchase Module

The purchase module serves as an aggregator of the data from the other modules described above or from an external source when users feed their own plans instead of using the create module. The operation of this platform is to offer a single gateway through which to buy media from thousands of publishers, adnetworks, adservers and search marketing gateways. In some embodiments, the purchase module queries only publishers that have published advertisements that appeared in the results of the search engine module. In some embodiments the purchase module queries a broader set of publishers. In some embodiments the purchase module queries an overlapping set of publishers that includes publishers that have advertisements that appear in the results and those that do not have advertisements that appear in the results.

If the user has used all of the above steps, then his campaign is ready to go live. He then selects a buy option in the media plan and a single media release order (or a plurality of orders) to generate that state all of the details of the campaign, which include some or all of: (1) vehicle publisher; (2) campaign name; (3) campaign duration; (4) number of impression; (5) creative sizes; (6) property placement; (7) rate; (8) discount if any; (9) taxes; and (10) net payable amount.

The Tracking Module

The tracking module is an integration with adservers that tracks for example, the performance of a campaign with parameters including conversion rates and clicks generated. Exemplary tracking modules would be those modules that allow communication with, integration with or use of tracking technology such as Doubleclick, Zedo and BrandCentral. A tool such as clickTag can be used to embed the creative element with a code that is given to publishers. When an impression is made or a click through is activated, the occurrence is registered and optionally demographic information of the server, location, etc. of the user who viewed and/or clicked through is registered as well.

According to one embodiment, the present invention provides a method for providing competitive analysis of online advertising to a user. According to this embodiment, one populates a search database with online media content files, wherein said populating comprises scraping a plurality of URLs. Next one indexes the search database to provide a set of key words for each online media content file, wherein each set of key words is associated with each online media content file. Then one searches within said key words for results, wherein said results comprise or describe a set of online media content files that match a user defined query. Next one displays the results to a user.

The scraping step may comprise assigning a fetcher thread to each of said plurality of URLs. The fetcher thread may query a representational state transfer web service to fetch a web page and to return the web page to the fetcher thread. The web service may use a headless browser to fetch the web page. In some embodiments at least two URLs are scraped. In other embodiments at least 5, 10, 20, 50, 100, 500, 1000, 10,000, 50,000, 100,000 URLs are scraped.

The indexing may comprise categorizing the online media content by media type. The indexing may further comprise analyzing meta-tags of the online media content for said set of key words.

The online media content files that are created may be in a plurality of file formats and the key words may be in a single file format or in a plurality of file formats.

According to a second embodiment, the present invention may provide a method for selecting and purchasing online media content, said method comprising any of the methods described herein and further comprising: (i) reviewing the results of the search of the index; (ii) applying a user defined criteria with respect to at least one publisher, wherein optionally the at least one publisher publishes an advertisement within said results: and (iii) selecting a publisher for launching an online advertisement, wherein said publisher satisfies said user defined criteria.

The user defined criteria may include one or more of the following: budget, location, key words, target audience, and duration of advertisement.

The user defined criteria may then be measured against one or more of the following parameters of a publishing opportunity: (a) website for advertisement placement; (b) region of placement; (c) market; (d) vertical connections; (e) monthly impressions; (f) unique users; (g) country wide IP impressions; (h) availability of creative sizes; (i) permissible creative weights; (j) permissible innovations; (k) property placements; (l) pricing in multiple currencies; (m) minimum buy; (n) rates; (o) taxes; (p) discounts; and (q) contact information. For example, the set of publisher criteria may comprise at least two, at least three, at least four, at least five, at least six, at least seven, at least eight, at least nine, at least ten, at least eleven, at least twelve, at least thirteen, at least fourteen, or at least fifteen of the elements.

The system may further comprise a creation module such that a user could use the tools within that module to create an advertisement that would easily be able to be uploaded by a publisher for publication. For example, the creation module may through a graphic user interface permit a user to do one or more of the following actions: (i) define a banner size and weight for a banner, wherein said banner comprises at least one frame; (ii) define the number of frames for the banner; (iii) fill a background image or color for said at least one frame; (iv) insert one or more images from a library, wherein said one or more images are at preset space allocations; (v) insert text on said at least one frame; and (vi) insert a company logo on said at least one frame. In some embodiments, all six are provided.

Because publishers use a variety of sizing parameters, if a publisher were selected prior to the creation of a creative piece or advertisement and its sizing requirements were known, it may be advantageous to limit the user's choices to be consistent with those requirements. Alternatively, if the publisher were not initially known, or its sizing parameters are not known, the creative module may contain a feature that enables resizing in a plurality of formats that would be acceptable to a plurality of publishers.

In another embodiment, the present invention provides a computer-based system for determining placement of online advertising. This system may comprise a scraper module, an index module, an input module and an output module. Preferably, the index module is operably coupled to said scraper module, said input module and said output module.

The scraper module may be capable of scraping a frame of an online content page in which an advertisement appears, thereby yielding a scraped frame. The index module may be configured to extract key words from said scraped frame, and the index module may be configured to be able to extract said key words from a plurality of file formats and to generate an index of key terms. Alternatively, the scraper module may extract the key words and the index module may index them. The input module may be capable of receiving a query for searching the index. The output module may be capable of displaying results of the query to a user. A central processing unit may be used to enable any one module to be coupled to any one or more other modules. Preferably, the central processing unit has the ability to access the Internet, and optionally is continuously or continually linked to the Internet to provide for rapid access to the desired URL sites by the scraper module.

Within the scope and spirit of the present invention are a combination of scraper and index modules in which the keywords are extracted by the scraper module to form a key words file for each media content page and then indexed by the index module, as well as embodiments in which the scraper locates advertisements and downloads them, but the index module controls the review of the pages for key words, including by using fetcher threads to progress through landing pages to which media files point. After locating the page, the landing page may then be reviewed.

In some embodiments, the scraper module has an automatic feature that activates access to URLs at a predetermined frequency. In some embodiments, the scraping is activated after a query is received.

In another embodiment, the present invention provides a computer readable storage medium for storing instructions that when executed by a computer cause the computer to execute a method for facilitating reviewing online media advertising.

This method comprises: (i) scraping online media; (ii) indexing said online media in an advertisement database; (iii) searching the advertisement database based on a set of criteria to generate results that represent the set of database entries that satisfy the criteria; and (iv) displaying the results.

The scraping may comprise (i) reading a list of URLs from within a URL database; (ii) allocating a thread for fetching to each URL; (iii) retrieving web page content for each URL; (iv) analyzing said web page content to determine whether any advertisements appear on said web page; and (v) downloading advertisements from the web page content into an advertisement database.

In some embodiments, the advertisement database may comprise identification of a publisher, click through information and placement of the advertisement for a plurality if not all advertisements. Additionally, in some embodiments, the indexing comprises identifying key words and the searching comprises applying a query to said key words. Further, the identifying step may comprise reviewing meta-tags.

According to another embodiment, the present invention provides a computer readable storage medium for storing instructions that when executed by a computer cause the computer to execute a method for purchasing online media advertising. The method comprises: (i) scraping online media; (ii) indexing an advertisement database that has been created by the scraping; (iii) searching the advertisement database based on a set of criteria to generate results that represent the set of database entries that satisfy the criteria; (iv) displaying the results; and (v) purchasing online media from a publisher. In some embodiments, the publisher previously published an advertisement that appeared in the results. The instructions may further cause the computer to receive criteria for a media plan, and to search for a publisher that satisfies or optimizes said criteria prior to executing said instruction to purchase online media.

The particular languages in which the software for the present invention may be programmed includes but are not limited to C, Java and the host application, .Net, Adobe, Flex, C# and Ajax.

Certain embodiments of the present invention may further be understood by reference to the accompanying figures.

FIG. 1 is a representation of the interaction of five modules of the present invention. A search module, 1, enables a user to review the placement and other parameters of a database of online advertisements that have previously been scraped and indexed, or to initiate new scraping and indexing and thus search what has newly been indexed. The search module may be configured to offer one or more of the following options or benefits: IP targeting, text focus, display focus, brand focus, live feed from publisher networks, campaign archive data, and free access. With the results of the search, a user may strategically use the plan module, 2, to determine how and where to launch a media campaign. The plan module may be configured to offer one or more of the following options or benefits: IP targeting, an intelligent analytics planner, publisher focus, and a source of revenue generation.

If the user has already created the advertisement the user may then engage the launch module, 3, through which the user may purchase and direct the dissemination and posting of the online content spots. The launch module may offer one or more of the following benefits or options: ad serving, integration, and a feed for searching. If the user has not already created his advertisement and/or wishes to modify the advertisement he may activate the create module, 4. The create module may offer one or more of the following benefits or options: creative generator library, portal focused creative optimizer, launch code generator for ad serving networks and a source of revenue generation.

After launch, and through the track module, 5, the user may monitor the number of impressions (viewings by persons) and click-throughs. The track module may be configured to offer one or more of the following benefits or options: pre-negotiated pricing, single insertion order, inventory availability, credit ratings and a loyalty program.

FIG. 2 is a representation of the process of scraping according to certain embodiments of the present invention. The process is activated and started, 18. A computer reads a list of URLs for portals through which to look for advertisements that are posted on websites 19. The computer looks to a database, 20, for this list, and it allocates one thread for fetching for each URL, 21. Exemplary different threads are represented by 22, 6 and 7.

Thread 1, operating through a proxy server, 8, accesses the Internet, 9, and obtains webpage contents, 10. Under a system of first in, first out (FIFO) each webpage is analyzed on a first in, first out basis, 11, as determined by lists of URLs. The proxy server enables the review of advertisements from various locations using a single central server.

Analysis of the webpage is conducted, 12, looking for Flash ads, 13. If there is no Flash ad, the image ad is analyzed for ad dimensions, 14, in order to determine whether it satisfies a predetermined banner ad criteria, 16. If this criteria is satisfied, or there is a Flash ad, one may download the ad, 15, and store it in a database, 17.

FIG. 3. is a representation of an indexing process according to certain embodiments of the present invention. After starting or initiating the process, 23, a list of files to be indexed is read, 24, from a database, 25. A thread for indexing is allocated for each file, 26. Exemplary different threads are represented by 27, 28 and 29. A flash ad is examined, 30, and the key words are obtained, 31. The internet is accessed to obtain the brand names, 32, and thus the key words for these meta-tags are obtained, 33. After the advertisement is scraped, based on the click through URL, the banner leads to the landing page and then from the meta-tags of the landing pages, the brand is identified.

The brand name and key words may then be put into the database and associated with the advertisement, 34, thereby updating the database, 35.

The computer system that may be used to implement the present invention may, for example, be a personal computer that is connected to the Internet through, for example, a serial bus port. Further the computer may comprise a central processing unit (CPU), read only memory (ROM) and random access memory (RAM). Additional memory systems, e.g. disks can be connected through a serial bus port. Similarly, input/output adaptors may be connected in order to enable a user to interact with the computer. By way of example, these devices include a keyboard, a mouse and a graphic user interface. In some embodiments the computer have at least 100 gigabytes of storage capacity.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings. Further, unless otherwise specified or apparent from context any feature described in connection with any one embodiment described above, may be used in connection with any other embodiment.

We claim:

1. A method for providing competitive analysis of online advertising to a user, said method comprising:
i. populating a search database with online media content files, wherein said populating comprises scraping a plurality of URLs;
ii. indexing said search database to provide a set of key words for each online media content file, wherein each set of key words is associated with each online media content file;
iii. searching within said key words for results, wherein said results comprise or describe a set of online media content files that match a user defined query; and
iv. displaying said results to said user.

2. The method according to claim 1, wherein said scraping comprises assigning a fetcher thread to each of said plurality of URLs.

3. The method according to claim 2, wherein said scraping further comprises using said fetcher thread to query a representational state transfer web service to fetch a web page and to return the web page to the fetcher thread.

4. The method according to claim 3, wherein said web service uses a headless browser to fetch said web page.

5. The method according to claim 1, wherein said indexing comprises categorizing the online media content by media type.

6. The method according to claim 5, wherein said indexing further comprises analyzing meta-tags of the online media content for said set of key words.

7. The method according to claim 6, wherein said online media content files are in a plurality of file formats and the key words are in a single file format.

8. The method according to claim 1, wherein said scraping comprises analyzing a plurality of links of a URL for media files that have an extension of at least one of jpeg, swf, gif or mpeg, and reviewing a landing page to which said at least one of jpeg, swf, gif or mpeg points for meta-tags.

9. A method for selecting and purchasing online media content, said method comprising the method according to claim 1 and further comprising:
i. reviewing said results;
ii. inputting a user definite set of criteria comprising at least one of the following parameters: budget, duration of advertisement placement, location, target audience, and key words;
iii. selecting a publisher for launching an online advertisement, wherein said publisher satisfies said user defined criteria; and
iv. placing an order for placement of an advertisement through said publisher for launching.

10. The method according to claim 9 further comprising creating an online advertisement and submitting said advertisement to said publisher for launching, wherein said creating comprises:
i. defining a banner size and weight for a banner, wherein said banner comprises at least one frame;
ii. defining the number of frames for the banner;
iii. filling a background image or color for said at least one frame;
iv. inserting one or more images from a library, wherein said one or more images are at preset space allocations;
v. inserting text on said at least one frame; and
vi. inserting a company logo on said at least one frame.

11. The method according to claim 10 further comprising determining the sizing parameters for placement of an advertisement placement with a desired publisher and reformatting said online advertisement to comply with said parameters.

12. A computer-based system for determining placement of online advertising, wherein said computer-based system comprises:
i. a scraper module, wherein said scraper module is capable of scraping a frame of an online content page in which an advertisement appears, thereby yielding a scraped frame;
ii. an index module, wherein said index module is configured to extract key words from said scraped frame, and said index module is configured to be able to extract said key words from a plurality of file formats and to generate an index of key terms;
iii. an input module, wherein said input module is capable of receiving a query for searching said index; and
iv. an output module wherein said output module is capable of displaying results of said query to a user,
wherein said index module is operably coupled to said scraper module, said input module and said output module.

13. The computer-based system of claim 12, wherein said being operably coupled is accomplished through a central processing unit and said central processing unit has access to the Internet.

14. The computer-based system of claim 13, wherein said scraper module has an automatic feature that instructs the scraper module to activate access to URLs at a predetermined frequency.

15. A computer readable storage medium for storing instructions that when executed by a computer cause the computer to execute a method for facilitating reviewing online media advertising, wherein said method comprises:
i. scraping online media, wherein said scraping comprises
a. reading a list of URLs from within a URL database;
b. allocating a thread for fetching to each URL;
c. retrieving web page content for each URL;
d. analyzing said web page content to determine whether advertisements appear on said web page; and
e. downloading advertisements from said web page content into an advertisement database;
ii. indexing said advertisement database;
iii. searching said advertisement database based on a set of criteria to generate results that satisfy said set of criteria; and
iv. displaying said results to a user.

16. The computer readable storage medium of claim 15, wherein said advertisement database comprises identification of a publisher, click through information and placement of the advertisement for a plurality of advertisements.

17. The computer readable storage medium of claim 16, wherein said indexing comprises identifying key words and said searching applying a query to said key words.

18. The computer readable storage media according to claim 17, wherein said identifying comprises reviewing meta-tags.

19. A computer readable storage medium for storing instructions that when executed by a computer cause the computer to execute a method for purchasing online media advertising comprising the computer readable storage media according to claim 18 and further comprising instructions that when executed cause the computer to purchase online media from a publisher, wherein said publisher previously published an advertisement that appeared in said results.

20. The computer readable storage media according to claim 19, wherein said instructions further cause the computer to receive criteria for a media plan, and to search for a publisher that satisfies said criteria prior to executing said instruction to purchase online media.
